(19) United States
(12) Patent Application Publication
(10) Pub. No.: US 2018/0179952 A1
(43) Pub. Date: Jun. 28, 2018

(54) ROTATING DETONATION ENGINE AND METHOD OF OPERATING SAME

(71) Applicant: General Electric Company, Schenectady, NY (US)

(72) Inventors: Andrew Maxwell Peter, Saratoga Springs, NY (US); Peter Daniel Silkowski, Scotia, NY (US); Thomas Michael Lavertu, Clifton Park, NY (US); Venkat Eswarlu Tangirala, Niskayuna, NY (US); Douglas Carl Hofer, Clifton Park, NY (US)

(21) Appl. No.: 15/390,120

(22) Filed: Dec. 23, 2016

(51) Int. Cl. F02C 3/16; F02C 3/04; F02C 5/02; F02C 9/28; F01D 5/02; F04D 29/32

(52) U.S. Cl. CPC F02C 3/16; F02C 3/04; F02C 5/02; F05D 2240/35; F01D 5/02; F04D 29/324; F05D 2220/32; F02C 9/28

(57) ABSTRACT

A turbine engine includes a rotating detonation combustor including a housing defining at least one combustion chamber. The rotating detonation combustor is configured for a rotating detonation process to occur within the at least one combustion chamber to generate a combustion flow including a first portion and a second portion. The turbine engine also includes a turbine coupled in flow communication with the rotating detonation combustor. The turbine is configured to receive the combustion flow from the rotating detonation combustor. The turbine includes a first blade and a second blade that rotate about an axis at a rotational frequency. The rotating detonation combustor and the turbine are configured for the combustion flow first portion to contact the first blade substantially continuously as the first blade rotates.

### BACKGROUND

The field of the invention relates generally to turbine engines, and more particularly, to rotating detonation turbine engines including combustors and turbines configured to receive combustion products from the combustors.

In rotating detonation engines and, more specifically, in rotating detonation combustors, a mixture of fuel and an oxidizer is ignited such that combustion products are formed. For example, the combustion process begins when the fuel-oxidizer mixture in a tube or a pipe structure is ignited via a spark or another suitable ignition source to generate a compression wave. The compression wave is followed by a chemical reaction that transitions the compression wave to a detonation wave. The detonation wave enters a combustion chamber of the rotating detonation combustor and travels along the combustion chamber. Air and fuel are separately fed into the rotating detonation combustion chamber and are consumed by the detonation wave. As the detonation wave consumes air and fuel, combustion products traveling along the combustion chamber accelerate and are discharged from the combustion chamber.

In at least some rotating detonation engines, combustion products are channeled towards a turbine. However, the turbine receives varying flows of combustion products due to the rotating detonations.

### BRIEF DESCRIPTION

In one aspect, a turbine engine is provided. The turbine engine includes a rotating detonation combustor including a housing defining at least one combustion chamber. The rotating detonation combustor is configured for a rotating detonation process to occur within the at least one combustion chamber to generate a combustion flow including a first portion and a second portion. The turbine engine also includes a turbine coupled in flow communication with the rotating detonation combustor. The turbine is configured to receive the combustion flow from the rotating detonation combustor. The turbine includes a first blade and a second blade that rotate about an axis at a rotational frequency. The rotating detonation combustor and the turbine are configured for the combustion flow first portion to contact the first blade substantially continuously as the first blade rotates.

In another aspect, a method of operating a turbine engine is provided. The turbine engine includes a compressor, a rotating detonation combustor, and a turbine. The method includes directing a pressurized fluid into at least one combustion chamber of the rotating detonation combustor from the compressor and initiating a rotating detonation process within the at least one combustion chamber. The rotating detonation combustor includes a housing defining the at least one combustion chamber. The rotating detonation combustor is configured to generate a combustion flow including a first portion and a second portion. The method also includes channeling the combustion flow from the at least one combustion chamber of the rotating detonation combustor toward the turbine. The turbine is configured to receive the combustion flow from the rotating detonation combustor. The turbine includes a first blade and a second blade that rotate about an axis at a rotational frequency. The rotating detonation combustor and the turbine are configured for the combustion flow first portion to contact the first blade substantially continuously as the first blade rotates.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an exemplary combined cycle power generation system;

FIG. 2 is a sectional schematic view of a gas turbine engine assembly of the combined cycle power generation system shown in FIG. 1 including a combustor and a turbine;

FIG. 3 is a front view of a portion of the turbine shown in FIG. 2;

FIG. 4 is an enlarged view of a portion of the turbine shown in FIG. 2 including a first blade; and

FIG. 5 is an enlarged view of a portion of the turbine shown in FIG. 2 including a second blade.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations are combined and interchanged; such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, a programmable logic controller (PLC), and application specific integrated circuit, and other programmable circuits, and these terms are used interchangeably herein. In the embodiments described herein, memory may include, but it not limited to, a computer-readable medium, such as a random access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include any computer program storage in memory for execution by personal computers, workstations, clients, and servers.

As used herein, the term “non-transitory computer-readable media” is intended to be representative of any tangible computer-based device implemented in any method of technology for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including without limitation, volatile and non-volatile media, and removable and non-removable media such as firmware, physical and virtual storage, CD-ROMS, DVDs, and any other digital source such as a network or the Internet, as well as yet to be developed digital means, with the sole exception being transitory, propagating signal.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

As used herein, a “detonation chamber” refers to any combustion device or system where a series of repeating detonations or quasi-detonations within the device cause a pressure rise and subsequent acceleration of the combustion products as compared to the pre-burned reactants. Throughout this disclosure, the terms “detonation” and “quasi-detonation” are used interchangeably to refer to a combustion process that produces a pressure rise and velocity increase higher than the pressure rise produced by a deflagration wave. Typical embodiments of detonation chambers include a means of igniting a fuel/oxidizer mixture, for example, a fuel/air mixture, and a confining chamber, in which pressure wave fronts initiated by the ignition process coalesce to produce a detonation wave. Each detonation or quasi-detonation is initiated either by external ignition, such as spark discharge or laser pulse, or by gas dynamic processes, such as shock focusing, autoignition or by another detonation via cross-firing. The geometry of the detonation chamber is such that the pressure rise of the detonation wave expels combustion products out the detonation chamber exhaust to produce a thrust force. In addition, rotating detonation combustors are designed such that a substantially continuous detonation wave is produced and discharged therefrom. As known to those skilled in the art, detonation may be accomplished in a number of types of detonation chambers, including detonation tubes, shock tubes, resonating detonation cavities, and annular detonation chambers.

The systems and methods described herein provide a turbine engine including a rotating detonation combustor and a turbine. During operation, detonations continuously travel around a detonation chamber of the rotating detonation combustor. The turbine includes a plurality of turbine blades that rotate about an axis. The detonation chamber and the turbine have a substantially annular shape. A combustion flow from the rotating detonations travels directly from the annular detonation chamber into the annular turbine. The turbine and combustor are phase locked such that a portion of the combustion flow from the detonation process contacts a section of the rotating turbine blades substantially continuously. In particular, the combustor operates with a detonation frequency that is substantially equal to a rotational frequency of the turbine blades. In addition, the detonation process is synchronized to positions of the rotating turbine blades. As a result, the turbine blades extract work from the varying combustion flow. For example, in some embodiments, the turbine blades are designed to extract work under varying pressures.

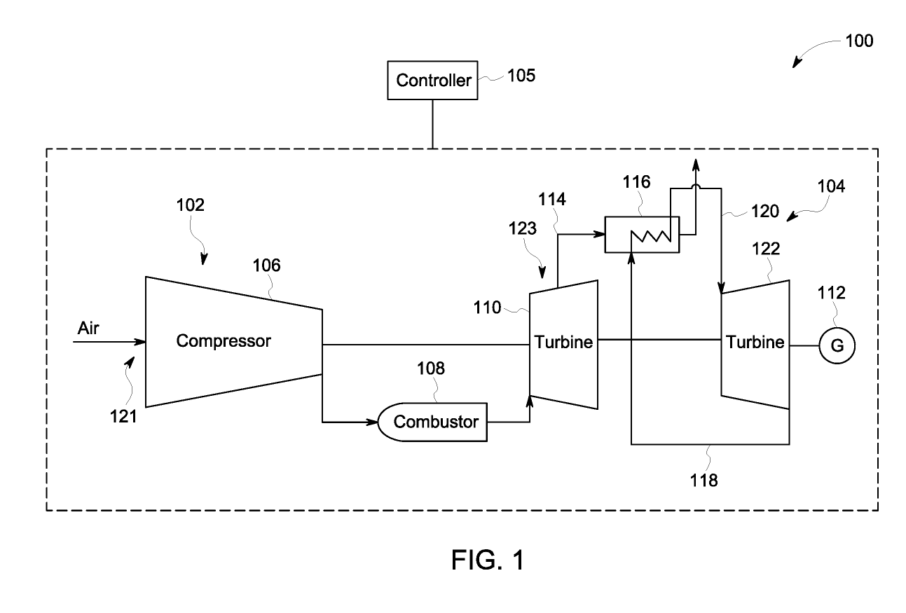

FIG. 1 is a schematic illustration of an exemplary combined cycle power generation system 100. Power generation system 100 includes a gas turbine engine assembly 102, a steam turbine engine assembly 104, and a controller 105. Gas turbine engine assembly 102 includes a compressor 106, a combustor 108, and a first turbine 110 powered by expanding hot gas produced in combustor 108 for driving an electrical generator 112. Gas turbine engine assembly 102 may be used in a stand-alone simple cycle configuration for power generation or mechanical drive applications. In the exemplary embodiment, exhaust gas 114 is channeled from first turbine 110 towards a heat recovery steam generator (HRSG) 116 for recovering waste heat from exhaust gas 114. More specifically, HRSG 116 transfers heat from exhaust gas 114 to water/steam 118 channeled through HRSG 116 to produce steam 120. Steam turbine engine assembly 104 includes a second turbine 122 that receives steam 120, which powers second turbine 122 for further driving electrical generator 112.

In operation, air enters gas turbine engine assembly 102 through an intake 121 and is channeled through multiple stages of compressor 106 towards combustor 108. Compressor 106 compresses the air and the highly compressed air is channeled from compressor 106 towards combustor 108 and mixed with fuel. The fuel-air mixture is combusted within combustor 108. High temperature combustion gas generated by combustor 108 is channeled towards first turbine 110. Exhaust gas 114 is subsequently discharged from first turbine 110 through an exhaust 123.

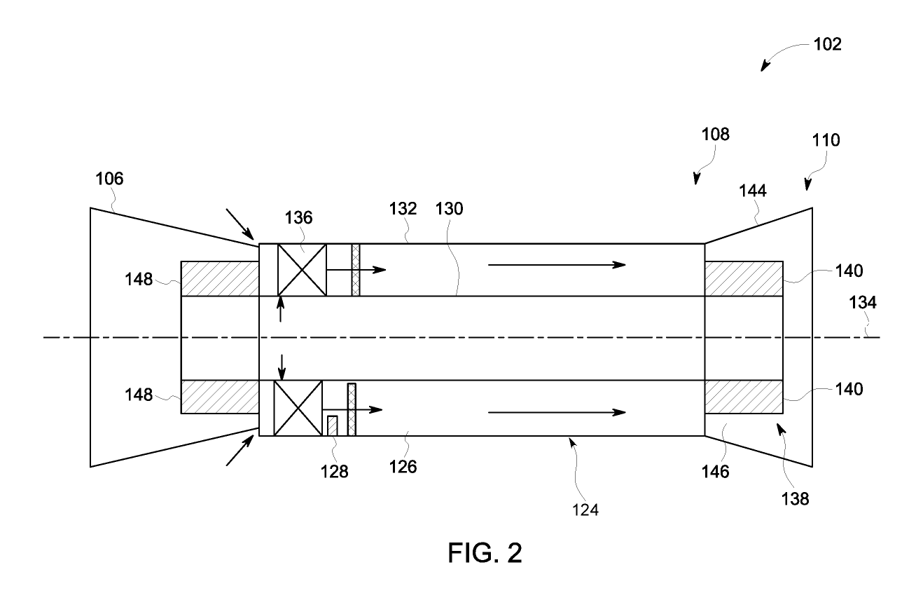

FIG. 2 is a sectional schematic view of gas turbine engine assembly 102 including combustor 108 and first turbine 110. In the exemplary embodiment, combustor 108 includes a housing 124 defining a combustion chamber 126. In addition, combustor 108 includes an ignitor 128, broadly an initiator or element. Ignitor 128 is used to initiate a rotating detonation process within combustion chamber 126. Accordingly, combustion chamber 126 is a detonation chamber. In alternative embodiments, combustor 108 includes any initiator that enables combustor 108 to operate as described herein. In some embodiments, combustor 108 includes a spark and/or plasma ignitor. In further embodiments, combustor 108 includes a predetonation initiator.

In the exemplary embodiment, housing 124 includes a radially inner side wall 130 and a radially outer side wall 132 that both extend circumferentially relative to a longitudinal axis 134 of combustor 108. Combustion chamber 126 is defined between radially inner side wall 130 and radially outer side wall 132. As such, combustion chamber 126 is annular. In alternative embodiments, combustor 108 includes any combustion chamber 126 that enables combustor 108 to operate as described herein. In further embodiments, combustion chamber 126 is any suitable geometric shape and does not necessarily include an inner liner and/or central body. For example, in some embodiments, combustion chamber 126 is substantially cylindrical.

Also, in the exemplary embodiment, combustion chamber 126 is configured to receive airflow, broadly an oxidizer flow, 127 and a fuel flow 129. In some embodiments, combustion chamber 126 is configured to receive a cooling flow to cool combustion chamber 126. For example, in some embodiments, both oxidizer flow and cooling flow are supplied by bleed air from compressor 106 (shown in FIG. 1). As used herein, the term “air” refers to an oxidizer. For example, in some embodiments, air includes oxygen and/or compressed air. A few examples of fuel types include, without limitation, hydrogen, distillate fuel, and natural gas. In alternative embodiments, combustion chamber 126 is configured to receive any flow that enables combustor 108 to operate as described herein.

In addition, in the exemplary embodiment, combustor 108 further includes a fuel-air mixing element 136 to provide a fuel-air mixture to combustion chamber 126. In some embodiments, a regulating component, such as a high frequency fuel control valve, regulates fuel and/or oxygen flow to fuel-air mixing element 136. In such embodiments, controller 105 is configured to control the regulating component and/or fuel-air mixing element 136 and the fuel-air mixture provided to combustion chamber 126. In alternative embodiments, combustion chamber 126 includes any mixing element that enables combustor 108 to operate as described herein. For example, in some embodiments, combustor 108 includes, without limitation, any of the following: a hypermixer, a swirler, a cavity, and any other mixing element.

During operation, compressor 106 provides compressed gas to combustor 108. Combustor 108 receives the compressed gas and performs a combustion process. In particular, ignitor 128 initiates a rotating detonation combustion process. During the rotating detonation combustion process, detonations or quasi-detonations continuously occur about combustion chamber 126. As a result, pressure is rapidly elevated within combustion chamber 126 before a substantial amount of gas escapes from combustion chamber 126. Accordingly, combustor 108 provides inertial confinement to produce near constant volume combustion during operation.

In reference to FIGS. 1 and 2, in the exemplary embodiment, compressor 106 has a reduced number of compressor stages because combustor 108 increases the pressure of the pressurized air during the rotating detonation process. For example, in the exemplary embodiment, compressor 106 includes 10 to 12 stages. However, the pressurized air moving through power generation system 100 has a pressure equivalent to the pressure of airflow through at least some systems that include compressors having more stages because combustor 108 increases the pressure of the pressurized air. In alternative embodiments, compressor 106 includes any stage that enables power generation system 100 to operate as described herein.

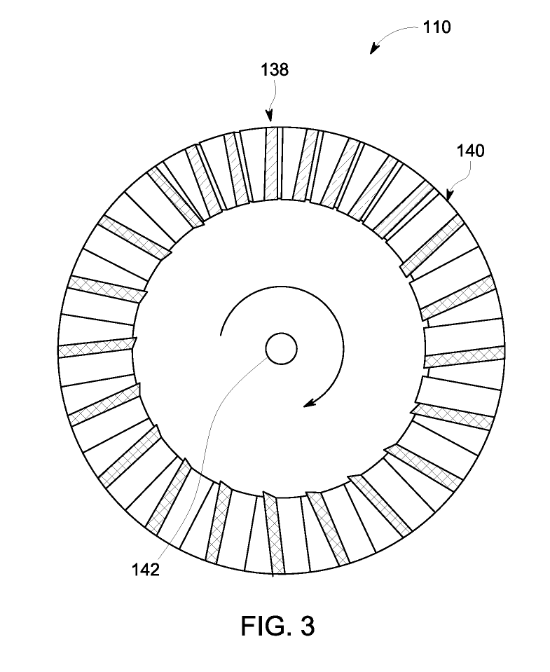

FIG. 3 is a front view of a portion of first turbine 110. First turbine 110 includes one or more stages or disk assemblies 138. Each stage 138 includes a plurality of turbine blades 140 coupled to a rotatable shaft 142. Turbine blades 140 and rotatable shaft 142 are configured to rotate about longitudinal axis 134 (shown in FIG. 2). In alternative embodiments, first turbine 110 includes any stage 138 that enables first turbine 110 to operate as described herein.

In the exemplary embodiment, turbine blades 140 are configured to extract power under varying conditions. In particular, in some embodiments, turbine blades 140 are configured to extract work from flows with varying pressures. For example, in some embodiments, turbine blades 140 vary along azimuths relative to a radial direction. In addition, in some embodiments, turbine blades 140 extend at different angles relative to each other. In further embodiments, turbine blades 140 include different geometric shapes. Accordingly, turbine blades 140 are configured to receive different flows and facilitate first turbine 110 extracting work from varying flows from combustor 108 (shown in FIG. 2). In alternative embodiments, first turbine 110 includes any turbine blade 140 that enables first turbine 110 to operate as described herein.

In reference to FIG. 2, in the exemplary embodiment, first turbine 110 further includes a housing 144. Housing 144 circumscribes the one or more stages 138. Housing 144 is substantially cylindrical and defines an annular space or cavity 146 between stages 138 and housing 144. Cavity 146 is configured to receive combustion flow from combustor 108. Turbine blades 140 extend within cavity 146 such that the combustion flow contacts turbine blades 140. When the combustion flow contacts turbine blades 140, turbine blades 140 extract work from the combustion flow, i.e., turbine blades 140 induce rotation of rotatable shaft 142 which is used to generate power. In alternative embodiments, first turbine 110 includes any housing 144 that enables first turbine 110 to operate as described herein.

In reference to FIGS. 2 and 3, in the exemplary embodiment, combustor 108 is directly coupled to housing 144 of first turbine 110. In addition, combustion chamber 126 is substantially the same cross-sectional shape and size as cavity 146 of first turbine 110. Accordingly, combustion products from combustion chamber 126 flow directly into cavity 146 of first turbine 110. In alternative embodiments, combustor 108 is coupled to first turbine 110 in any manner that enables power generation system 100 to operate as described herein. For example, in some embodiments, a transition piece and/or at least one nozzle is coupled between combustor 108 and first turbine 110.

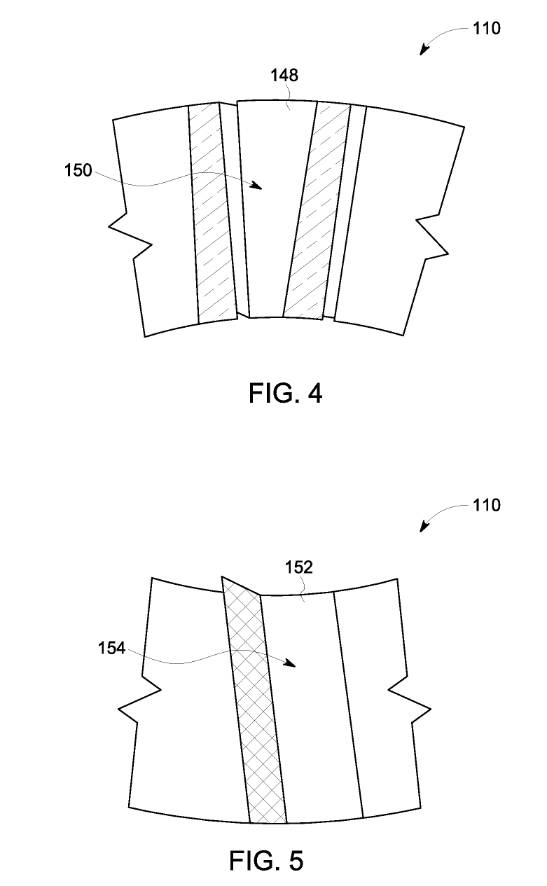

FIG. 4 is an enlarged view of a portion of first turbine 110 including a first blade 148 configured to extract work from a first portion 150 of combustion flow from combustor 108. FIG. 5 is an enlarged view of a portion of first turbine 110 including a second blade 152 configured to extract work from a second portion 154 of combustion flow from combustor 108. In the exemplary embodiment, first blade 148 is configured to extract work from fluid having a first pressure ratio and second blade 152 is configured to extract work from fluid having a second pressure ratio that is lower than the first pressure ratio. As used herein, the term “pressure ratio” refers to a comparison of a first fluid pressure measured at a first location along a flowpath and a second fluid pressure measured at a second location along the flowpath. Accordingly, first blade 148 and second blade 152 facilitate first turbine 110 extracting work from fluid having varying pressure ratios. In alternative embodiments, first turbine 110 includes any blade that enables first turbine 110 to operate as described herein.

In reference to FIG. 2, in the exemplary embodiment, first portion 150 and second portion 154 are discrete portions or streams of combustion flow 141. First portion 150 has substantially constant flow conditions that differ from the flow conditions of second portion 154. For example, in the exemplary embodiment, first portion 150 has a higher pressure ratio than second portion 154. First portion 150 and second portion 154 move about combustion chamber 126 due to the rotating detonation combustion process. In particular, first portion 150 and second portion 154 move circumferentially about combustion chamber 126 at a rate substantially equal to the detonation frequency of combustor 108. In alternative embodiments, combustion flow 141 includes any portion that enables gas turbine engine 102 to operate as described herein.

Also, in the exemplary embodiment, power generation system 100 is configured such that combustor 108 is phase locked with rotation of turbine blades 140 during operation of power generation system 100. For example, the rotating detonations have a frequency that is substantially equal to the rotational frequency of turbine blades 140. In addition, the position of the rotating detonations substantially corresponds to a position of turbine blades 140. As a result, portions of a combustion flow 141 from combustor 108 contact predetermined sections of turbine blades 140 substantially continuously as turbine blades 140 rotate. For example, first blade 148 (shown in FIG. 4) receives substantially the same flow, i.e., first portion 150, throughout the rotation of turbine blades 140. In addition, second blade 152 (shown in FIG. 5) receives substantially the same flow, i.e., second portion 154, throughout the rotation of turbine blades 140. Accordingly, turbine blades 140 are able to efficiently extract work from combustion flow 141.

Moreover, in the exemplary embodiment, power generation system 100 is configured such that the rotating detonations of combustor 108 are phase locked with first turbine 110 in any manner that enables power generation system 100 to operate as described herein. In some embodiments, combustion chamber 126 has a volume and is configured for combustion flow 141 to flow along combustion chamber 126 such that portions of combustion flow 141 contact predetermined sections of turbine blades 140. In further embodiments, a fuel is provided to combustor 108 such that portions of combustion flow 141 contact predetermined sections of turbine blades 140. For example, in some embodiments, the fuel flow to combustor 108 is a varied and used to direct portions of combustion flow 141. In some embodiments, an initiator such as ignitor 128 is configured to direct portions of combustion flow 141 such that portions of combustion flow 141 contact predetermined sections of turbine blades 140. For example, in some embodiments, controller 105 regulates ignitor 128 and ignitor 128 directs combustion flow by initiating a detonation periodically and/or when combustion flow 141 is misaligned and/or operating at a frequency different from the rotational frequency of rotating turbine blades 140.

In some embodiments, compressor 106 is configured to facilitate portions of combustion flow 141 contacting predetermined sections of turbine blades 140. For example, in some embodiments, compressor 106 includes blades 156 that are configured to rotate at a speed to provide compressed airflow to combustor 108 such that portions of combustion flow 141 contact predetermined sections of turbine blades 140. In further embodiments, compressor 106 includes compressor blades 156 that have different geometric shapes configured to provide varying flow of compressed air to combustor 108.

In some embodiments, controller 105 is configured to control at least one of compressor 106, combustor 108, and first turbine 110 such that portions of combustion flow 141 contact predetermined sections of turbine blades 140. For example, in some embodiments, controller 105 is configured to control at least one of the following: a rotational speed of compressor blades, the detonation frequency of the rotating detonation process within combustion chamber 126, fuel flow to combustor 108, the rotational frequency of turbine blades 140, flow through timed bleed ports around the circumference of compressor 106, and positions of compressor stators that are moved individually and/or in sub-groups. In alternative embodiments, controller 105 controls any component of power generation system 100 that enables power generation system 100 to operate as described herein.

In reference to FIGS. 1-3, a method of operating combined cycle power generation system 100 includes directing pressurized fluid into combustion chamber 126 of combustor 108. The pressurized fluid includes a mixture of fuel and air. Ignitor 128 is used to ignite the pressurized fluid and initiate a rotating detonation process within combustion chamber 126. The method also includes directing combustion products from combustion chamber 126 of combustor 108 towards first turbine 110. The method further includes directing a combustion flow from combustion chamber 126 towards first turbine 110 such that portions of combustion flow 141 contact predetermined sections of turbine blades 140. In particular, a detonation frequency is substantially equal to a rotational frequency of turbine blades 140 and the positions of portions of combustion flow 141 and turbine blades 140 are synchronized. Accordingly, combustor 108 and turbine blades 140 are phase locked.

The above-described embodiments provide a turbine engine including a rotating detonation combustor and a turbine. During operation, detonations continuously travel around a detonation chamber of the rotating detonation combustor. The turbine includes a plurality of turbine blades that rotate about an axis. The detonation chamber and the turbine have a substantially annular shape. A combustion flow from the rotating detonations travels directly from the annular detonation chamber into the annular turbine. The turbine and combustor are phase locked such that a portion of the combustion flow from the detonation process contacts a section of the rotating turbine blades substantially continuously. In particular, the combustor operates with a detonation frequency that is substantially equal to a rotational frequency of the turbine blades. In addition, the detonation process is synchronized to positions of the rotating turbine blades. As a result, the turbine blades extract work from the varying combustion flow. For example, in some embodiments, the turbine blades are designed to extract work under varying pressures.

An exemplary technical effect of the methods, systems, and apparatus described herein includes at least one of: (a) increasing the efficiency of rotating detonation engines; (b) increasing pressure of fluid flow through rotating detonation engines; (c) increasing power production of rotating detonation engines; and (d) increasing the efficiency of a turbine converting energy from varying combustion flow into work.

Exemplary embodiments of methods, systems, and apparatus for a gas turbine engine are not limited to the specific embodiments described herein, but rather, components of systems and steps of the methods may be utilized independently and separately from other components and steps described herein. For example, the methods may also be used in combination with other combustors, and are not limited to practice with only the gas turbine engines and methods as described herein. Rather, the exemplary embodiment can be implemented and utilized in connection with many other applications, equipment, and systems that may benefit from the advantages described herein.

Although specific features of various embodiments of the disclosure may be shown in some drawings and not in others, this is for convenience only. In accordance with the principles of the disclosure, any feature of a drawing may be referenced and claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A turbine engine comprising:
a rotating detonation combustor including a housing defining at least one combustion chamber, said rotating detonation combustor configured for a rotating detonation process to occur within said at least one combustion chamber to generate a combustion flow including a first portion and a second portion; and
a turbine coupled in flow communication with said rotating detonation combustor, said turbine configured to receive the combustion flow from said rotating detonation combustor, said turbine including a first blade and a second blade that rotate about an axis at a rotational frequency, said rotating detonation combustor and said turbine configured for the combustion flow first portion to contact said first blade substantially continuously as said first blade rotates.

2. The turbine engine in accordance with claim 1, wherein the combustion chamber has a substantially annular shape, and wherein said rotating detonation combustor is configured such that a detonation frequency of the rotating detonation combustor corresponds to the rotational frequency of said turbine.

3. The turbine engine in accordance with claim 2, wherein said first blade is configured to extract work from the combustion flow first portion and said second blade is configured to extract work from the combustion flow second portion, the combustion flow first portion having a first pressure ratio and the combustion flow second portion having a second pressure ratio different from the first pressure ratio.

4. The turbine engine in accordance with claim 1, wherein the combustion chamber has an inner volume that is configured for the combustion flow to flow along the combustion chamber such that the combustion flow first portion contacts said first blade as said first blade rotates.

5. The turbine engine in accordance with claim 1 further comprising at least one compressor configured to increase pressure of a fluid and channel pressurized fluid towards said rotating detonation combustor, wherein said at least one compressor comprises a plurality of compressor blades configured to rotate at a speed determined to provide compressed fluid to said rotating detonation combustor such that the combustion flow first portion contacts said first blade as said first blade rotates.

6. The turbine engine in accordance with claim 1 further comprising at least one compressor configured to increase pressure of a fluid and channel pressurized fluid towards said rotating detonation combustor, wherein said at least one compressor comprises a plurality of blades configured to provide compressed fluid to said rotating detonation combustor such that the combustion flow first portion contacts said first blade as said first blade rotates.

7. The turbine engine in accordance with claim 1, wherein said first turbine blade has a first shape and said second turbine blade has a second shape different from the first shape.

8. The turbine engine in accordance with claim 1 further comprising a fuel source configured to provide a fuel to said rotating detonation combustor, wherein said fuel source is configured to provide a variable fuel flow such that the combustion flow first portion contacts said first blade as said first blade rotates.

9. The turbine engine in accordance with claim 1 further comprising an initiator configured to initiate a detonation process, wherein said initiator is used to direct the combustion flow such that the combustion flow first portion contacts said first blade as said first blade rotates.

10. The turbine engine in accordance with claim 1 further comprising a controller configured to regulate at least one of said at least one compressor, said rotating detonation combustor, and said turbine such that the combustion flow first portion contacts said first blade as said first blade rotates.

11. The turbine engine in accordance with claim 10, wherein said controller is further configured to regulate at least one of the following: a rotational speed of a plurality of compressor blades, the detonation frequency of said rotating detonation chamber, a supply of fuel to said rotating detonation combustor, the rotational frequency of said plurality of turbine blades, flow through timed bleed ports around the circumference of compressor, and positions of compressor stators that are moved individually and/or in sub-groups.

12. A method of operating a turbine engine, the turbine engine including a compressor, a rotating detonation combustor, and a turbine coupled in serial flow communication, said method comprising:
directing a pressurized fluid into at least one combustion chamber of the rotating detonation combustor from the compressor;
initiating a rotating detonation process within the at least one combustion chamber, the rotating detonation combustor including a housing defining the at least one combustion chamber, the rotating detonation combustor configured to generate a combustion flow including a first portion and a second portion; and
channeling the combustion flow from the at least one combustion chamber of the rotating detonation combustor toward the turbine, the turbine configured to receive the combustion flow from the rotating detonation combustor, the turbine including a first blade and a second blade that rotate about an axis at a rotational frequency, the rotating detonation combustor and the turbine configured for the combustion flow first portion to contact the first blade substantially continuously as the first blade rotates.

13. The method in accordance with claim 12, wherein initiating a rotating detonation process within the at least one combustion chamber comprises initiating a rotating detonation process within the at least one combustion chamber such that a detonation frequency corresponds to the rotational frequency of the turbine.

14. The method in accordance with claim 12, wherein channeling the combustion flow from the at least one combustion chamber of the rotating detonation combustor toward the turbine comprises channeling the combustion flow from the at least one combustion chamber of the rotating detonation combustor toward the turbine such that the combustion flow second portion contacts the second blade as the second blade rotates.

15. The method in accordance with claim 12 further comprising directing the combustion flow along a combustion chamber of the rotating detonation combustor, wherein the combustion chamber has an inner volume that is configured for the combustion flow to flow along the combustion chamber such that the combustion flow first portion contacts the first blade as the first blade rotates.

16. The method in accordance with claim 12 further comprising rotating a plurality of compressor blades at a rotational speed determined to provide compressed fluid to the rotating detonation combustor such that the combustion flow first portion contacts the first blade as the first blade rotates.

17. The method in accordance with claim 12 further comprising rotating a plurality of compressor blades, wherein the plurality of compressor blades have different geometric shapes configured to provide compressed fluid to the rotating detonation combustor such that the combustion flow first portion contacts the first blade as the first blade rotates.

18. The method in accordance with claim 12 further comprising rotating the first blade and the second blade such that the turbine extracts work from varying flow conditions, wherein the first turbine blade has a first shape and a second turbine blade has a second shape different from the first shape.

19. The method in accordance with claim 12 further comprising providing a fuel to the rotating detonation combustor and regulating the fuel flow such that the combustion flow first portion contacts the first blade.

20. The method in accordance with claim 12 further comprising initiating a detonation process to direct the combustion flow such that the combustion flow first portion contacts the first blade.
